(19) United States
(12) Patent Application Publication
(10) Pub. No.: US 2009/0015128 A1
(43) Pub. Date: Jan. 15, 2009

(54) LIGHT EMITTING DEVICE WITH ELECTRODE COMPRISING A CERAMIC MATERIAL

(75) Inventors: Uwe Chittka, Herzogenrath (DE); Daniela Buttner, Aachen (DE); Pieter Johannes Stobbelaar, Eindhoven (NL); Saskia Tromp-Van Den Bogaerdt, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,854

(22) PCT Filed: May 31, 2006
(86) PCT No.: PCT/IB06/51731

§ 371 Date: Nov. 29, 2007

(30) Foreign Application Priority Data
Jun. 2, 2005 (EP) 05104796.7

(51) Int. Cl. H01J 1/14

(52) U.S. Cl. 313/346 R

(57) ABSTRACT

The invention relates to a light-emitting device comprising an electrode with a ceramic oxide material, which is brought in to contact with a reducing agent or a precursor thereof. The reducing agent serves to bind the released oxygen and to control the performance of the light-emitting device.

### FIELD OF THE INVENTION

This invention relates to the field of light emitting devices, especially fluorescent lamps.

### BACKGROUND OF THE INVENTION

To meet the increasing demand for fluorescent lamps with more stringent life time specifications emitters that are based on complex ceramic oxide structures such as barium tantalates (Ba₁₋ₓCaₓ)_{6-y}Ta₂O_{11-y} with 0<x<1 and y<6 have been investigated. Delrieu et al. have described compounds like these in U.S. Pat. No. 2,677,623 already in the 1950s. Due to their ceramic structure these compounds are advantageous in comparison to binary oxide materials with respect to robustness against sputtering and against moisture.

With the last property a more controlled processing outside the lamp would be enabled with a better lifetime performance. Unfortunately this enhanced robustness is accompanied with a reduced transport of the alkaline earth metal (electron emitting species, especially barium) and thus with a reduced electron emissivity.

It is therefore an object of the present invention to provide a light-emitting device, with an improved emissive material, which enables a high emittance as well as an improved lifetime performance of the light-emitting device.

This object is solved by a light emitting device, in particular a fluorescent lamp, comprising a electrode comprising a ceramic material which is essentially made out of material selected out of the group (M^{I})_{6-y}M^{II}₂O_{11-y} whereby M^{I} is selected out of the group comprising alkaline earth metals or mixtures thereof, whereby M^{II} is selected out of the group comprising Ta, Nb or mixtures thereof, and y is ≧0 and ≦6, or mixtures thereof, which is brought in contact with at least one reducing compound and/or at least one precursor compound which decomposes during processing and/or lamp operation into one or more reducing compound(s).

Accordingly, a light-emitting device is provided comprising an electrode comprising a ceramic material, which is essentially made out of material selected from the group (M^{I})_{6-y}M^{II}₂O_{11-y}, whereby M^{I} is selected out of the group comprising alkaline earth metals or mixtures thereof whereby M^{II} is selected out of the group comprising Ta, Nb or mixtures thereof and y is ≧0 and ≦6 or mixtures thereof; which is brought in contact with at least one reducing compound and/or at least one precursor compound which decomposes during processing and/or lamp operation into one or more reducing compound(s).

In particular the light-emitting device is a fluorescent lamp. Preferably, y is ≧0.5 and ≦5, more preferred ≧1 and ≦4, yet more preferred ≧2 and ≦3 and most preferred ≧2.4 and ≦2.8.

The inventors have found out that problems of a low electron emissivity that are caused by a low transport of suitable metals, such as barium, which are accompanied with the release of oxygen and thus with the consumption of mercury can be reduced by using a reducing element as presented within the present invention.

In the sense of the present invention, a reducing compound is in particular a compound, which has a low electronegativity in comparison to tungsten.

The reducing compound as employed within the present invention is preferably selected according to the given application. However, the following features have been shown to be advantageous for most applications and embodiments within the present invention:

The reactivity should be in balance with the net transport (loss) rate of atomic alkaline earth metal during lamp operation, i.e. it should be low enough to avoid premature oxidation during emitter/lamp processing and to avoid excessive release of alkaline earth metal and formation of stable compounds.

Compounds that are formed as a result of the reduction reaction should not bind to much earth alkali metal and preferably these compounds should not reduce the electron emissivity.

To provide for the last property the absolute value of the enthalpy of formation should be sufficiently low or/and the activation energy should be sufficiently high and no significant poisoning effect with respect to the electron emissivity should occur.

The inventors have found out that by a reducing compound and/or precursor compound according to the present invention, not only the oxygen released during operation of the lamp is bound, but that surprisingly the reducing compound and/or precursor compound also serves as to “crack”, i.e. to decompose, the ceramic material by reacting with the oxygen contained in the ceramic material. This opens up the possibility to control the reaction rate of the ceramic material, since by administering the properties of the ceramic material and/or the reducing compound and/or precursor compound, the performance of the light emitting device can also be improved.

Surprisingly it has been found that the use of a reducing compound according to the present invention in combination with a niobate and/or tantalate-like emitter shows a further advantage, that due to the increase of oxygen vacancies the alkaline earth metal mobility in the crystals is additionally increased and resulting niobate and/or tantalate phases show an increased electron emission.

In the sense of the present invention, the term “bringing into contact” means in particular that the ceramic material and the reducing compound(s) and/or precursor compound(s) are located in the ultimate vicinity of each other so that a reaction between those is possible and/or are located in such a way towards each other that at least transport mechanisms during lamp operation enable such reactions.

In the sense of the present invention, the term “essentially made of” means a wt-% content of ≧90, preferably ≧95, more preferred ≧98, most preferred ≧99 and ≦100.

According to a preferred embodiment of the present invention, the ceramic material is brought into contact with the reducing compound and/or precursor compound by mixing and/or coating of the electrode and/or the ceramic material. This has the advantage that a close contact between the reducing and/or precursor compound and the ceramic material can be ensured. Preferably, the reducing compound and/or precursor compound is provided in form of a coating.

According to a preferred embodiment of the present invention, the thickness d of the coating is ≧0.05 σ·V to ≦10 σ·V, whereby σ is a factor of 0.1 μmol per mm² surface area of the electrode and V is the molar volume V of the reducing agent.

Preferably, the thickness d of the coating is ≧0.11 σ·V to ≦5 σ·V, more preferably the thickness d of the coating is ≧0.2 σ·V to ≦2 σ·V and most preferred the thickness d of the coating is ≧0.5 σ·V to ≦1.5 σ·V.

According to a preferred embodiment of the present invention, the thickness d of the coating is ≧0.1 μm to ≦8 μm, preferably ≧0.2 μm≦6 μm, more preferably ≧0.4 μm to ≦4 μm, and most preferred ≧0.6 μm≦2 μm.

The inventors have found out that by adapting the thickness of the coating in this way, the lifetime of the lighting emitting device can be furthermore enhanced and a more controlled performance of the lighting emitting device be achieved.

According to a preferred embodiment of the present invention, the reducing compound and/or precursor compound is provided as a macroscopic structure. A macroscopic structure in the sense of the present invention means, that the reducing and/or precursor compound is provided inside the light emitting device in form of a structure which has in at least one dimension an extension or length of ≧0.1 mm. By doing so, the reduction of the ceramic material occurs via transport reactions inside the lamp. By properly adjusting the size and/or the position, i.e. sufficiently exposed to the plasma, of the macroscopic structure, a control of the reaction between the reducing compound and/or the precursor compound and the ceramic material is possible.

According to a preferred embodiment of the present invention, the reducing compound and/or precursor compound is provided in form of particles. This also enables a control of the reaction between the reducing compound and/or the precursor compound and the ceramic material.

According to a preferred embodiment of the present invention, the rate of the reaction between the reducing compound and/or the compound which is set free by decomposition of the precursor compound is set to reduce the alkaline earth metal in the ceramic compound with a rate of ≧0.1 to ≦0.01 μg/h.

This reaction rate was shown to be the appropriate rate in order to achieve an improved behaviour of the lamp, especially concerning the improvement of the longevity of the lamp.

The reaction rate can be controlled by providing the reducing compound as shown above and be measured by monitoring the lifetime of the lamp.

According to a preferred embodiment of the present invention, the precursor compound, which decomposes during processing and/or lamp operation into one or more reducing compounds, furthermore only decomposes into substances which are readily decomposable and/or which have a low work function. This ensures that no harmful components will be released by the decomposition of the precursor compound. Besides the release of the desired reducing compound, only harmless by-products are set free.

According to a preferred embodiment of the present invention, the reducing compound and/or precursor compound comprises a metal material which is selected out of the group comprising Mg, Sc, Y, La, rare earth metals, Ti, Zr, Hf, V, Nb, Ta, Ni, B, Al, Si and mixtures thereof. These materials have shown to be the best suitable materials for the present invention.

According to a preferred embodiment of the present invention, the precursor compound comprises at least one metal compound as a hydride.

Such a precursor compound will decompose during processing and/or performance of the lamp, thus releasing the metal compound, which serves then as the reducing compound.

According to a preferred embodiment, the electro negativity of the reducing compound and/or the compound which is set free by decomposing of the precursor compound is 0.7≦χ≦2.5. This has shown to be the optimum range of electro negativity in order to achieve the optimum reaction rate, as described above. The electro negativity is more preferably 1.1≦χ≦2.2, most preferably 1.3≦χ≦2.0.

According to a preferred embodiment of the present invention, the particle size of the reducing compound and/or the precursor compound is ≧0.1 μm and ≦200 μm.

The inventors have found out, that by setting the particle size between these margins, the overall behavior of the light-emitting device can be greatly improved. Preferably, the particle size of the reducing compound is ≧0.5 μm and ≦150 μm, more preferred ≧2.0 μm and ≦100 μm.

It is believed, that the improvement of choosing the particle size of the reducing compound and/or the precursor compound as described is that the reaction between this/these compound(s) and the ceramic material occurs with the optimal reaction velocity. Using a powder with a smaller particle size results in a “burn down” of the reducing compound and/or precursor compound, whereas a too high particle size results in a too slow reaction, thus hindering the reducing compound and/or precursor compound to act as desired.

According to a preferred embodiment of the present invention, the adjusted particle size d_{ad}, which is defined as d_{ad}=log₁₀(d·χ^{2.5}) with d being the particle size, and χ the electro negativity of the reducing compound and/or the compound which is set free by decomposing of the precursor compound is ≧0.2 and ≦2.5.

The inventors have surprisingly found out that by setting the adjusted particle size in this way, an even more improved reaction rate of the reducing compound and/or precursor compound and the ceramic material can be obtained. Preferably, d_{ad} is ≧0.5 and ≦2, more preferred ≧1 and ≦1.8.

According to a preferred embodiment of the present invention, the ceramic material is (M^{I}₁₋ₓCaₓ)_{6-y}M^{III}₂O_{11-y}, whereby M^{I} is selected out of the group comprising alkaline earth metals except Ca or mixtures thereof, whereby M^{III} is selected out of the group comprising Ta, Nb or mixtures thereof, x is ≧0 and ≦1, and y is ≧0 and ≦6.

The inventors have found out that a calcium content in the given margins of this preferred embodiment, a surprisingly stable compound was formed with significantly reduced number of defects and hardly any agglomerates after calcination/sintering/firing. Preferably, y is ≧0.05 and ≦5.5, more preferred ≧1 and ≦5. Preferably, x is ≧0.1 and ≦0.8, more preferred ≧0.15 and ≦0.4 and most preferred ≧0.2 and ≦0.3.

According to a preferred embodiment of the present invention, the ceramic material is (Ba₁₋ₓCaₓ)_{6-y}Ta₂O_{11-y} with y being ≧0 and ≦6 and x being ≧0 and ≦1. Preferably, y is ≧0.5 and ≦5, more preferred ≧1 and ≦4, yet more preferred ≧2 and ≦3 and most preferred ≧2.4 and ≦2.8. Preferably, x is ≧0.01 and ≦0.8, more preferred ≧0.05 and ≦0.4 and most preferred ≧0.1 and ≦0.3.

This has also shown to be a suitable material for use within the present invention.

A light-emitting device according to the present invention may be of use in a broad variety of systems and/or applications, amongst them one or more of the following: household application systems, shop lighting systems, home lighting systems, accent lighting systems, spot lighting systems, theater lighting systems, fiber-optics application systems, projection systems, self-lit display systems, pixilated display systems, segmented display systems, warning sign systems, medical lighting application systems, indicator sign systems, backlighting systems, decorative lighting systems, portable systems, automotive applications.

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, characteristics and advantages of the object of the invention are disclosed in the sub claims, the figures and the following description of the respective figures and examples—which in an exemplary fashion—show several preferred embodiments of a light emitting device according to the invention.

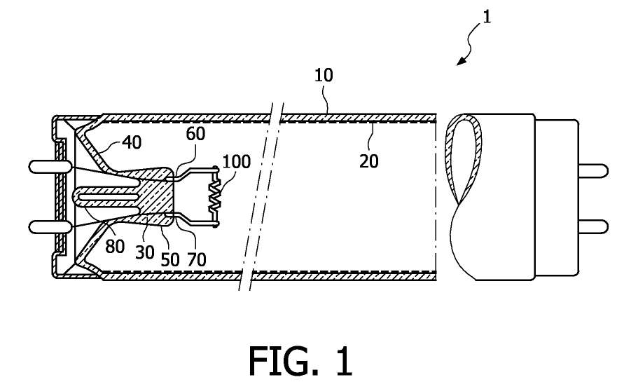

FIG. 1 shows a side view, partially in section, of a light-emitting device in form of a fluorescent lamp according to an embodiment of the present invention.

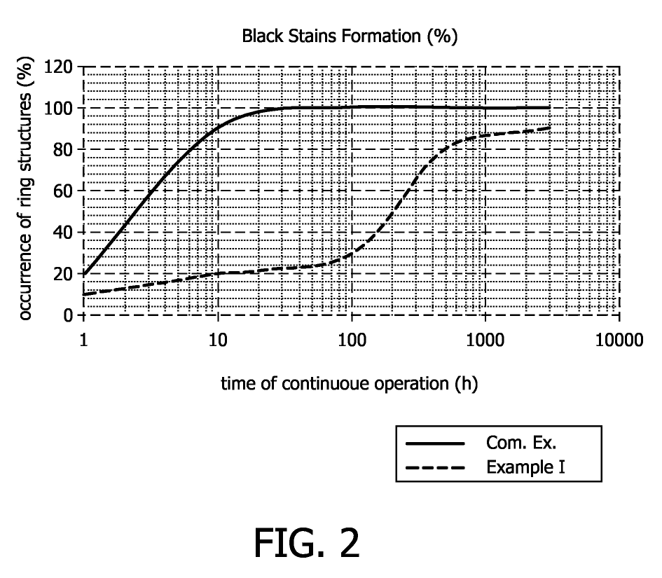

FIG. 2 shows a diagram of the number of lamps (in percent) that formed regular, ring shaped black stains in lamps of an inventive example I and a comparative Example I.

FIG. 1 shows a side view, partially in section, of a light-emitting device in form of a fluorescent lamp 1 according to an embodiment of the present invention. The lamp comprises an envelope 10, which may be coated by a phosphor coating 20. An electrode stem 30 seals the ends of the envelope, which comprises a flare 40 and a pinch seal 50, through which two lead-wires 60 and 70 extend. It also contains the exhaust tube 80. The lamp 1 also contains two electrode coils 100. These coils have cores, which are preferably of tungsten and which are also provided with the ceramic material and the reducing compound and/or the precursor compound as described above according to the invention. Preferably, the electrode coil 100 is coated with the ceramic material and the reducing compound and/or precursor compound. However, the reducing and/or precursor compound may also be provided in form of a macroscopic structure and/or as particles as described above.

A light emitting device according to the invention is—in a merely exemplarily fashion—furthermore illustrated by the following example:

### EXAMPLE I

A light-emitting device as shown in FIG. 1 was used for the inventive Example I. The phosphor-coated lamp-vessels had 10 mm diameters and length of 42 cm between the 6Ω electrodes. Beside mercury also 5 mbar argon as buffer gas was filled in. Philips HF-Matchbox HF-M 118 PLC/PLT SH served as power supply. In a high vacuum coating unit titanium layers, which served as the reducing element were superimposed on the tungsten coils. The coils were then dip-coated by using a suspension of a ceramic material in an adopted admixture of binder cellulose nitrate and of solvent butyl acetate. The ceramic material consisted of Ba_{5.4}Ca_{0.6}Ta₂O₁₁.

### COMPARATIVE EXAMPLE I

The comparative example I was provided in the same manner as Example I except that no Ti-layers were used.

The light emitting devices according to Example I and Comparative Example I were then operated in a continuous manner and the amount of lamps, which showed black stains in form of ring structures, were measured. These stains result from the deposition of oxidized mercury on the lamp surface and are related to the maintenance of the lamp.

FIG. 2 shows a diagram of the number of lamps (in percent) that formed regular, ring shaped black stains of lamps of an inventive Example I and a comparative Example I. It should be noted that for better visibility the time scale is logarithmic.

The formation of black stains of the inventive and comparative example over time during continuous operation was measured. The percentage of lamps, which showed these black stains, was then recorded against the time of continuous operation, as shown in FIG. 2.

In the diagram it can be clearly seen that in the inventive example the formation of black stains is significantly delayed. Furthermore, whereas in the comparative example, 100% of the lamps show black stains, even after approx. 3000 h of continuous operation some of the lamps according to the example showed no stains at all.

1-10. (canceled)

11. Light emitting device, in particular a fluorescent lamp, comprising an electrode comprising a ceramic material which is essentially made out of a material having a formula (M^{I})_{6-y}M^{II}₂O_{11-y}, wherein M^{I} is selected from alkaline earth metals or mixtures thereof, M^{II} is selected from Ta, Nb or mixtures thereof, and y is ≧0 and ≦6, the ceramic material being in contact with at least one reducing compound and/or at least one precursor compound decomposable during processing and/or lamp operation into at least one reducing compound, the reducing compound or precursor compound being provided in the form of a coating, the reducing compound or precursor compound being provided in the form of a coating of the electrode and/or the ceramic material and comprising a metal material which is selected from the group consisting of Mg, Sc, Y, La, rare earth metals, Ti, Zr, Hf, V, Nb, Ta, Ni, B, Al, Si, and mixtures thereof.

12. Light emitting device according to claim 11, whereby the electro negativity of the reducing compound and/or the compound which is set free by decomposing of the precursor compound is 0.7≦χ≦2.5.

13. Light emitting device according to claim 11, whereby the rate of the reaction between the reducing compound and/or the compound which is set free by decomposition of the precursor compound is set to reduce the alkaline earth metal in the ceramic compound with a rate of ≧0-0.1 to ≦0.01 μg/h.

14. Light emitting device according to claim 11, whereby the particle size of the reducing compound and/or precursor compound is ≧0.1 μm and ≦100 μm and/or the adjusted particle size d_{ad}, which is defined as d_{ad}=log₁₀(d·χ^{2.5}) with d being the particle size, and χ the electro negativity of the reducing compound and/or the compound which is set free by decomposing of the precursor compound.

15. A light emitting device according to claim 11, whereby the thickness d of the coating is ≧0.7 σ·V to ≦1.3 σ·V, whereby σ is a factor of 0.1 per mm² surface area of the electrode and V is the molar volume V of the reducing agent.

16. A light emitting device according to claim 11, whereby the ceramic material is (M^{I}₁₋ₓCaₓ)_{6-y}M^{III}₂O_{11-y}, whereby M^{I} is selected from the group comprising alkaline earth metals except Ca or mixtures thereof, whereby M^{III} is selected from the group comprising Ta, Nb or mixtures thereof, x is ≧0 and ≦1, and y is ≧0 and ≦6.

17. A light emitting device according to claim 11, whereby the ceramic material is (Ba₁₋ₓCaₓ)_{6-y}Ta₂O_{11-y} with y being ≧0 and ≦6 and x being ≧0 and ≦1.

18. A system comprising a light emitting device according to claim 11, the system being used in one or more of the following applications: household application systems, shop lighting systems, home lighting systems, accent lighting systems, spot lighting systems, theatre lighting systems, fiber-optics application systems, projection systems, self-lit display systems, paginated display systems, segmented display systems, warning sign systems, medical lighting application systems, indicator sign systems, backlighting systems, decorative lighting systems, portable systems, automotive applications.

19. A light emitting device according to claim 11, whereby the ceramic material is (Ba₁₋ₓCaₓ)_{6-y}Ta₂O_{11-y} with y being ≧0 and ≦6 and x being ≧0 and ≦1.

20. A system comprising a light emitting device according to claim 11, the system being used in one or more of the following applications: household application systems, shop lighting systems, home lighting systems, accent lighting systems, spot lighting systems, theatre lighting systems, fibber-optics application systems, projection systems, self-lit display systems, paginated display systems, segmented display systems, warning sign systems, medical lighting application systems, indicator sign systems, backlighting systems, decorative lighting systems, portable systems, automotive applications.
